(19) United States
(12) Patent Application Publication
(10) Pub. No.: US 2021/0130675 A1
(43) Pub. Date: May 6, 2021

(54) VISCOSITY MODIFIERS AND METHODS OF USE THEREOF

(71) Applicant: BAKER HUGHES, A GE COMPANY, LLC, Houston, TX (US)

(72) Inventors: Shannon E. BRYANT, Tomball, TX (US); Terry D. MONROE, Tomball, TX (US); Sumit BHADURI, Spring, TX (US); Mark A. VORDERBRUGGEN, Spring, TX (US)

(73) Assignee: Baker Hughes, a GE company, LLC, Houston, TX (US)

(21) Appl. No.: 16/491,886

(22) PCT Filed: Mar. 20, 2017
(86) PCT No.: PCT/US2017/023164

§ 371 Date: Sep. 6, 2019

(51) Int. Cl. C09K 8/42; C09K 8/467; C09K 8/40; C04B 28/00; C04B 28/26; C04B 22/06; E21B 33/13

(52) U.S. Cl. CPC C09K 8/424; C09K 8/467; C09K 8/40; E21B 33/13; C04B 28/26; C04B 22/066; C04B 28/001

(57) ABSTRACT

A method of cementing a wellbore comprises injecting into the wellbore a cement slurry comprising an aqueous carrier, a swellable nanoclay, and a solid delayed releasing divalent inorganic salt comprising calcined magnesium oxide, calcined calcium oxide, calcium magnesium polyphosphate, a borate, a nitride, a silicate, an agent having a cation of Ba²⁺, Sr²⁺, Fe²⁺, Ni²⁺, or a combination comprising at least one of the foregoing; and allowing the cement slurry to set.

### BACKGROUND

This disclosure relates to downhole treatment compositions containing viscosity modifiers and methods of using such compositions in downhole operations.

Downhole treatment compositions are used for various purposes such as for drilling, cementing, and fluid displacement. A spacer fluid is a liquid used to physically separate one special-purpose liquid from another during a drilling operation. A cement spacer fluid separates drilling fluid from cement during cementing operations in a well bore. A cement slurry can be used to cement a wellbore or to form a cement plug at a desired location of the well.

Viscosity profile is often a critical property differentiating the effectiveness of various treatment compositions in achieving various functions. For example, treatment compositions are often pumped downhole. Accordingly it is desirable for the treatment compositions to have such a viscosity that they can be conveniently prepared on the surface and remain pumpable during the treatment. Meanwhile, treatment compositions often transport solids downhole or carry solids to surface. Therefore, treatment compositions should also have sufficient viscosity to ensure that the solids do not settle out. Viscosity modifiers have been used in the past to adjust the viscosity of cement slurries and spacer fluids. In view of the extensive use of viscosity modifiers in downhole applications, the art would be receptive to cost effective alternative materials. It would be a further advantage if the alternative viscosity modifiers can impart additional benefits to the treatment compositions.

### BRIEF DESCRIPTION

A method of cementing a wellbore comprises injecting into the wellbore a cement slurry comprising an aqueous carrier, a swellable nanoclay, and a solid delayed releasing divalent inorganic salt comprising calcined magnesium oxide, calcined calcium oxide, calcium magnesium polyphosphate glass, a borate, a nitride, a silicate, an agent having a cation of Ba²⁺, Sr²⁺, Fe²⁺, Ni²⁺, or a combination comprising at least one of the foregoing; and allowing the cement slurry to set.

A method of displacing a first fluid from a wellbore comprises injecting the first fluid into the wellbore; and displacing the first fluid with a spacer fluid comprising an aqueous carrier, a swellable nanoclay, and a solid delayed releasing divalent inorganic salt comprising calcined magnesium oxide, calcined calcium oxide, polyphosphate or phosphonate, a borate, a nitride, a silicate, an agent having a cation of Ba²⁺, Sr²⁺, Fe²⁺, Ni²⁺, or a combination comprising at least one of the foregoing.

### BRIEF DESCRIPTION OF THE DRAWINGS

The following descriptions should not be considered limiting in any way. With reference to the accompanying drawings, like elements are numbered alike:

FIG. 1 is a graph showing the viscosity over time as temperature increases of a base fluid containing 25 lb Laponite but not calcined magnesium oxide, a fluid containing 5 lb Laponite and 5 lb calcined magnesium oxide, and a fluid containing 5 lb Laponite and 2.5 lb calcined magnesium oxide;

FIG. 2 is a graph showing the viscosity over time as temperature increases of a fluid containing 5 lb Laponite but not calcined magnesium oxide and fluids containing 10 lb, 5 lb and 2.5 lb calcined magnesium oxide but not Laponite; and

FIG. 3 is a graph showing the viscosity over time as temperature increases of fluids containing 12.5 lb Laponite and 6.25 lb calcium magnesium oxide either with or without barite, and a fluid containing 12.5 lb Laponite but no calcined magnesium oxide or barite.

### DETAILED DESCRIPTION

It has been found that viscosity modifiers described herein impart desirable properties to a variety of downhole treatment compositions such as cement slurries or spacer fluids. The desirable properties include reduced transition time that helps cement develop gel strength faster while it is transitioning from a slurry to set cement. The viscosity modifiers also provide increased and stable viscosity at temperatures over 300° F. to allow the cement slurries and spacer fluids to suspend solids in wellbores having a high wellbore temperature. In addition, the viscosity modifiers are effective to adjust the viscosity increase onset temperature and the degree of viscosity increase thus allowing the preparation of spacer fluids having low viscosity at surface mixing temperatures meanwhile having increased viscosity at higher wellbore temperatures where solids tend to settle out of the spacer fluids.

As used herein, the viscosity modifier contains a nanoclay and a solid delayed releasing divalent inorganic salt that includes calcined magnesium oxide, calcined calcium oxide, calcium magnesium polyphosphate, a borate, a nitride, a silicate, an agent having a cation of Ba²⁺, Sr²⁺, Fe²⁺, Ni²⁺, or a combination comprising at least one of the foregoing.

The nanoclay is a water-swellable mineral clay separated into a layered form, i.e., exfoliated. Thus, preferred nanoclays are insoluble in water but hydrate and swell to give clear and colorless colloidal dispersions. Preferred mineral clays swell and can be uniformly dispersed in an aqueous solution (water or a mixed solvent of water and an organic solvent), and can separate into single layers or a level close thereto in an aqueous medium. For example, water-swellable smectite or water-swellable mica can be used, specific examples of which include water-swellable hectorite, water-swellable montmorillonite, water-swellable saponite, and water-swellable synthetic mica, containing sodium as an interlayer ion. These mineral clays may also be used as a combination comprising at least one of the foregoing. In a specific embodiment, the nanoclay is a synthetic layered hectorite magnesium lithium silicate such as Laponite.

The delayed releasing divalent inorganic salt is a solid. As used herein, delayed releasing means that the divalent inorganic salt is present as a solid initially and has a slow dissolution rate in water at room temperature. Only at elevated temperatures or after mixing with water for an extended period of time, the divalent inorganic salt slowly releases a divalent metal cation in solution.

Preferably the solid delayed releasing divalent inorganic salt is calcined magnesium oxide, calcined magnesium oxide, calcium magnesium polyphosphate glass, or a combination comprising at least one of the foregoing. As used herein, calcined magnesium oxide and calcined calcium oxide refer to magnesium oxide and calcium oxide that have been heat treated either at a temperature of about 1000° C.-1500° C. or from 1500° C. to 2000° C. before they are incorporated in a spacer fluid or cement slurry. Without wishing to be bound by theory, it is believed that the calcined magnesium oxide and/or calcined calcium oxide treated to 1500° C. (referred to hard burned) or to 2000° C. (referred to dead burned) increases the insolubility of these products when exposed to water.

The calcium magnesium polyphosphate glass described herein is also obtained by a refractory method by exposing calcium and magnesium oxides to high temperatures (900° C.-1200° C.) in the presence of phosphoric acid. This process allows extremely low dissolution rates of these products in water. This product is available as PSI-2 from Baker Hughes Incorporated.

The viscosity modifier can be incorporated into a spacer fluid or a cement slurry. In an embodiment, a spacer fluid comprises an aqueous carrier, a nanoclay, and a solid delayed releasing divalent inorganic salt comprising calcined magnesium oxide, calcined calcium oxide, calcium magnesium polyphosphate glass, a borate, a nitride, a silicate, an agent having a cation of Ba²⁺, Sr²⁺, Fe²⁺, Ni²⁺, or a combination comprising at least one of the foregoing.

In the spacer fluid, the nanoclay is present in an amount of about 0.1 to about 25 wt. %, specifically about 0.1 to about 20 wt %, more specifically about 0.1 to about 10 wt. %, based on the weight of the aqueous carrier in the spacer fluid.

In the spacer fluid, the solid delayed releasing divalent inorganic salt is present in an amount of about 0.1 to about 5 wt. %, specifically about 0.1 to about 4 wt. %, more specifically about 0.1 to about 2.5 wt. %, based on the weight of the aqueous carrier in the spacer fluid.

The aqueous carrier can be fresh water, brine (including seawater), an aqueous acid (for example a mineral acid or an organic acid), an aqueous base, or a combination comprising at least one of the foregoing. It will be appreciated that other polar liquids such as alcohols and glycols, alone or together with water, may be used in the carrier fluid.

The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from an underground reservoir source of fresh water or brackish water. Produced water can also be referred to as reservoir brine and contain components including barium, strontium, and heavy metals. In addition to naturally occurring brines (e.g., seawater and produced water), completion brine can be synthesized from fresh water by addition of various salts for example, KCl, NaCl, ZnCl₂, MgCl₂, or CaCl₂ to increase the density of the brine, such as about 10.6 pounds per gallon of CaCl₂ brine. Completion brines typically provide a hydrostatic pressure optimized to counter the reservoir pressures downhole. The above brines can be modified to include one or more additional salts. The additional salts included in the brine can be NaCl, KCl, NaBr, MgCl₂, CaCl₂, CaBr₂, ZnBr₂, NH₄Cl, sodium formate, cesium formate, and combinations comprising at least one of the foregoing. The salt can be present in the brine in an amount of about 0.5 to about 50 weight percent (wt. %), specifically about 1 to about 40 wt. %, and more specifically about 1 to about 25 wt. %, based on the weight of the fluid.

The aqueous carrier of the spacer fluid can be foamed with a liquid hydrocarbon or a gas or liquefied gas such as nitrogen, or air. The fluid can further be foamed by inclusion of a non-gaseous foaming agent. The non-gaseous foaming agent can be amphoteric, cationic, or anionic. Suitable amphoteric foaming agents include alkyl betaines, alkyl sultaines, and alkyl carboxylates. Suitable anionic foaming agents can include alkyl ether sulfates, ethoxylated ether sulfates, phosphate esters, alkyl ether phosphates, ethoxylated alcohol phosphate esters, alkyl sulfates, and alpha olefin sulfonates. Suitable cationic foaming agents can include alkyl quaternary ammonium salts, alkyl benzyl quaternary ammonium salts, and alkyl amido amine quaternary ammonium salts. A foam system is mainly used in low pressure or water sensitive formations. A mixture of foaming and foam stabilizing dispersants can be used. Generally, the mixture can be included in the spacer fluid in an amount of about 1% to about 5% by volume of water in the spacer fluid.

The spacer fluid can further comprise other components known for use in spacer fluids, for example a viscosifier, a viscosifier crosslinker, a pH control agent, a surfactant, a weighting agent, a lubricant, a fluid loss agent, a clay stabilizer, a biocide, an acid, a corrosion inhibitor, friction reducer, oxygen scavenger, formation fines controller, foamer, gel stabilizer, or a combination comprising at least one of the foregoing. These additional components are selected so as to avoid imparting unfavorable characteristics to the spacer fluid, to avoid damage to equipment in contact with the spacer fluid, and to avoid damaging the wellbore or subterranean formation.

The various properties of the spacer fluids can be varied and can be adjusted according to well control and compatibility parameters of the particular drilling fluid, cement slurry, or other fluid being segregated. For example, the viscosity of the spacer fluid can be varied over a wide range such as an apparent viscosity (AV) from about 0.9 to about 200 centiPoise (cP).

The density of the spacer fluid can vary over a wide range. In an embodiment, the spacer fluid is heavier (denser) than the preceding fluid (e.g., a 12 ppg drilling fluid and then a 14 ppg spacer and then a 16 ppg cement).

The spacer fluid can be premixed or is injected without mixing, e.g., injected “on the fly” where the components are combined as the spacer fluid is being injected downhole. The order of addition can be varied and the time of injecting each is the same or different.

The spacer fluid can be used to displace another fluid in a wellbore. Accordingly, a method of displacing a first fluid from a wellbore comprises injecting the first fluid into the wellbore and displacing the first fluid with a spacer fluid. The spacer fluids can also be utilized as a buffer between two fluids during subterranean operations. For example, in some embodiments, the spacer fluid is pumped into a wellbore between a first fluid and a second fluid. The first fluid is displaced with the spacer fluid, and the spacer fluid is then displaced with the second fluid. Among other things, the spacer fluids is compatible with the fluid that it is displacing and the second fluid that is displacing the spacer fluid, in that there are no undesirable interactions between the spacer fluid and the first or the second fluid. Generally, the first fluid may be any fluid that the spacer fluid should displace, such as drilling fluids. The second fluid may be any fluid desired to be introduced into the well bore, such as cement slurries and the like.

Viscosity of conventional spacer fluids is very difficult to maintain at temperatures of 300 to 400° F., and it is even more difficult to design a spacer with low surface viscosity that still has enough viscosity at high temperatures to provide slurry stability. Use of the spacer fluids disclosed herein provides a number of benefits. The spacer fluids disclosed herein have low viscosity at surface mixing temperatures but elevated viscosity at higher wellbore temperatures where solids tend to settle out of the spacer. The spacer fluids disclosed herein are stable at high wellbore temperatures, for example above 300° F. The spacer fluids are compatible with both drilling fluid and the cement slurries that they are used in conjunction with. Additionally, the spacer fluids can more effectively remove drilling muds and contaminant particles from wellbores, for example drilling fluid particulates, drilling cuttings, and particles of reservoir rock sloughed into the drilled wellbore from weak formations, for example a shale particulate, mudstone particulate, sandstone particulate, carbonate particulate, and the like. The spacer fluids can further suppress mixing of drilling fluids and cement slurries when compared to turbulent flow spacer fluids.

The methods and compositions further have the advantages of improved cementing, by reducing the amount of drilling fluids, contaminant particles, and other debris before introducing the cement slurry. It will be appreciated that it is not necessary for all of the drilling fluids or all of the contaminant particulate to be removed for the method and its compositions to be considered successful. Success is obtained if more drilling fluids, particles and other contamination are removed using the spacer fluid than if it is not used. In general, of course, it is desirable to remove as much of the drilling fluids, contamination and debris as possible.

The viscosity modifier can also be incorporated into a cement slurry. A cement slurry comprises an aqueous carrier, a cement component, a nanoclay, and solid delayed releasing divalent inorganic salt comprising calcined magnesium oxide, calcined calcium oxide, calcium magnesium polyphosphate glass, a borate, a nitride, a silicate, an agent having a cation of Ba²⁺, Sr²⁺, Fe²⁺, N²⁺, or a combination comprising at least one of the foregoing.

In the cement slurry, the nanoclay is present in an amount of about 0.1 to about 25 wt. %, specifically about 0.1 to about 20 wt %, more specifically about 0.1 to about 10 wt. %, based on the weight of the aqueous carrier in the spacer fluid.

In the cement slurry, the solid delayed releasing divalent inorganic salt is present in an amount of about 0.1 to about 5 wt. %, specifically about 0.1 to about 4 wt. %, more specifically about 0.1 to about 2.5 wt. %, based on the weight of the aqueous carrier in the spacer fluid.

The cement component of the cement slurry can be any cementitious material that sets and hardens by reaction with water, and is suitable for forming a set cement downhole, including mortars and concretes. Suitable cement components include those typically employed in a wellbore environment, for example those comprising calcium, aluminum, silicon, oxygen, and/or sulfur. Such cements include, but are not limited to, Portland cements, pozzolan cements, gypsum cements, high alumina content cements, silica cements, and high alkalinity cements, or combinations of these. Portland cements are particularly useful. In some embodiments, the Portland cements that are suited for use are classified as Class A, B, C, G, and H cements according to American Petroleum Institute, API Specification for Materials and Testing for Well Cements, and ASTM Portland cements classified as Type I, II, III, IV, and V. The cements herein also can include various concretes by the further addition of aggregates, such as a coarse aggregate made of gravel or crushed rocks such as chert, quartzite, granite, and/or a fine aggregate such as sand or crushed sand. Aggregate can be added in an amount of about 10% to about 70% by weight of the hydraulic cement, and more particularly about 20% to about 40% by weight.

The cement component can be present in the slurry in an amount of about 50 to about 95 wt. %, preferably about 60 to about 90 wt. %, more preferably about 65 to about 85 wt. %, based on the total weight of the cement slurry.

The carrier for the cement slurry can be the same as the carrier for the spacer fluid. It can be foamed in a similar way as the aqueous carrier for the spacer fluid.

The cement slurry can further comprise other components known for use in cementing, for example a setting accelerator to reduce setting time, a setting retardant to extend setting time, a fluid loss control agent, an extender to lower density, a foaming agent to reduce density, a weighting agent to increase density, a dispersant to reduce viscosity, other fluid loss control agents, thixotropic agents, a bridging agent or lost circulation material (e.g., gilsonite or cellophane flakes), silicate materials such as sand, silica flour, fumed silica, act to strengthen cement as well as protect from strength retrogression effects at temperatures above 230° F., clay stabilizers, or a combination comprising at least one of the foregoing. These additive components are selected to avoid imparting unfavorable characteristics to the cement slurries, and to avoid damaging the wellbore or subterranean formation. Each additive can be present in amounts generally known to those of skill in the art.

The slurry is pumpable. A pumpable cement slurry can have a viscosity lower than 1000 mPa-s at a shear rate of 100 s⁻¹. The cement slurry is a low-density cement slurry or a high-density cement slurry. While the density of a low-density cement slurry such as a scavenger can vary widely depending on downhole conditions, such densities can include about 5 to about 12 pounds per gallon (ppg) when foamed. When unfoamed the density of a scavenger or low-density cement slurry can vary with such densities between about 9 up to about 15 pounds per gallon, or about 10 to about 14 pounds per gallons, or about 11 up to about 13 pounds per gallon. The high density cement slurries can have a density of about 15 to about 25 pounds per gallon.

A pumpable or pourable cement slurry can be formed by any suitable method. In an exemplary embodiment, a slurry or mixture comprising the nanoclay, the inorganic salt, the cement component, and water or the aqueous carrier is combined using conventional cement mixing equipment. The cement slurry can then be injected, e.g., pumped and placed by various conventional cement pumps and tools to any desired location within the wellbore to fill any desired shape form. Once the cement slurry has been placed and assumed the shape form of the desired downhole article, the slurry is allowed to set and form a permanent shape of the base cement article, for example a casing or cement plug.

The cement slurries are particular useful for cementing a wellbore. A method can include injecting, generally pumping, into the wellbore the cement slurry containing the solid delayed releasing divalent inorganic salt at a pressure sufficient to displace a drilling fluid, for example a drilling mud, a cement spacer, or the like, optionally with a “lead slurry” or a “tail slurry”. The cement slurry can be introduced between a penetrable/rupturable bottom plug and a solid top plug. Once placed, the cement slurry is allowed to harden, and in some embodiments, forms a cement plug in the wellbore annulus, which prevents the flow of reservoir fluids between two or more permeable geologic formations that exist with unequal reservoir pressures. Usually, the slurry hardens by hydration and gelation of the cement. As is known by those of skill in the art, a high degree of variability exists in the above description of well cementation (e.g., multiple bottom plugs, graduated fluid densities, etc.), and can be effected using preformed synthetic polymers described herein.

The methods and compositions further have the advantages of improved cementing by reducing the transition time for the cement slurry to set. The beneficial effects of using viscosity modifiers described herein are further illustrated in the following examples.

### EXAMPLES

Laponite nanoclay, a synthetic layered silicate, was obtained from BYK Additives & Instruments (Formerly Rockwood Additives) and used without further purification. Calcined magnesium oxide was obtained from Baker Hughes Incorporated.

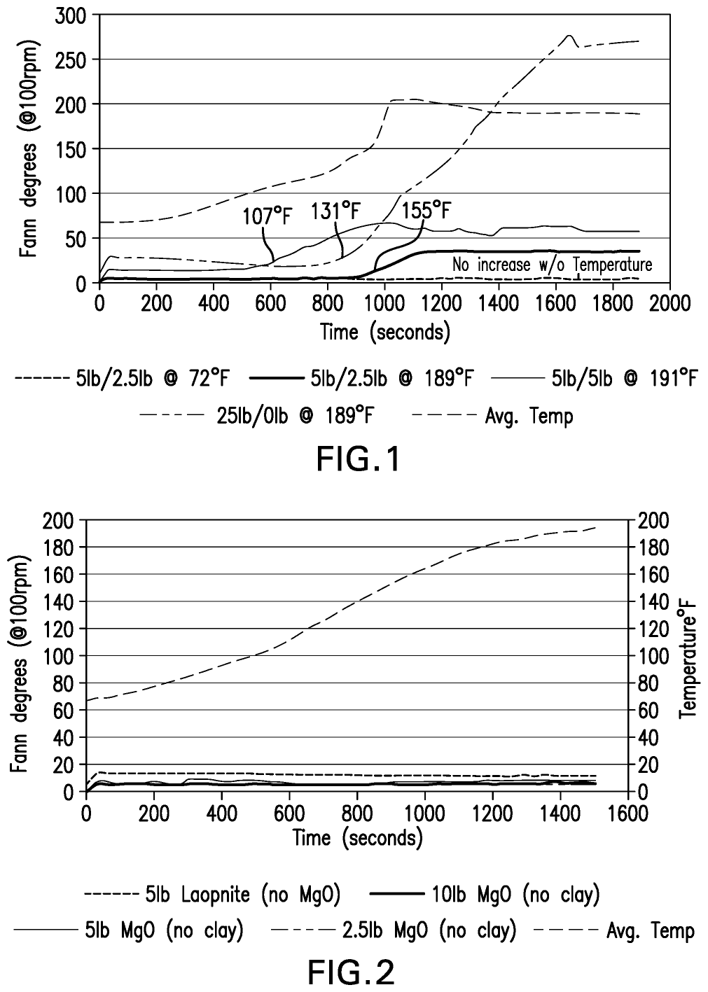

Samples A-C were prepared. Sample A contained water and 25 lb Laponite nanoclay. Sample B contained water, 5 lb Laponite, and 5 lb calcined magnesium oxide. Sample C contained water, 5 lb Laponite and 2.5 lb calcined magnesium oxide. The viscosity of Samples A-C over time at different temperatures was measured using Grace Instrument M3600 Viscometer. The results are shown in FIG. 1. The plotted temperature is average. Actual heat up rates varied.

FIG. 1 indicates that 25 lb Laponite nanoclay alone (sample A) provides too much viscosity. When calcined magnesium oxide is added, the viscosity increase is delayed and the extent of the viscosity increase can also be adjusted to a desired level by varying the amounts of the Laponite nanoclay or the calcined magnesium oxide. Samples B and C provide varying degrees of viscosity at different elevated temperatures. If an elevated temperature is not applied, no increase in viscosity is observed. FIG. 1 also shows that adding calcined magnesium oxide lowers the temperature when viscosity starts increasing.

Samples D-G were prepared. Sample D contained water and 5 lb Laponite nanoclay. Sample E contained water and 10 lb calcined magnesium oxide. Sample F contained water and 5 lb calcined magnesium oxide. Sample G contained water and 2.5 lb calcined magnesium oxide. The viscosity of Samples D-G over time at different temperatures was measured using Grace Instrument M3600 Viscometer. The results are shown in FIG. 2. The plotted temperature is average. Actual heat up rates varied.

FIG. 2 indicate that fluids containing calcined magnesium oxide but not Laponite nanoclay do not show an increase in viscosity even an elevated temperature is applied to the fluids. In addition, the fluid containing Laponite nanoclay but not calcined magnesium oxide does not shown an increase in viscosity at temperatures below 200° F. either.

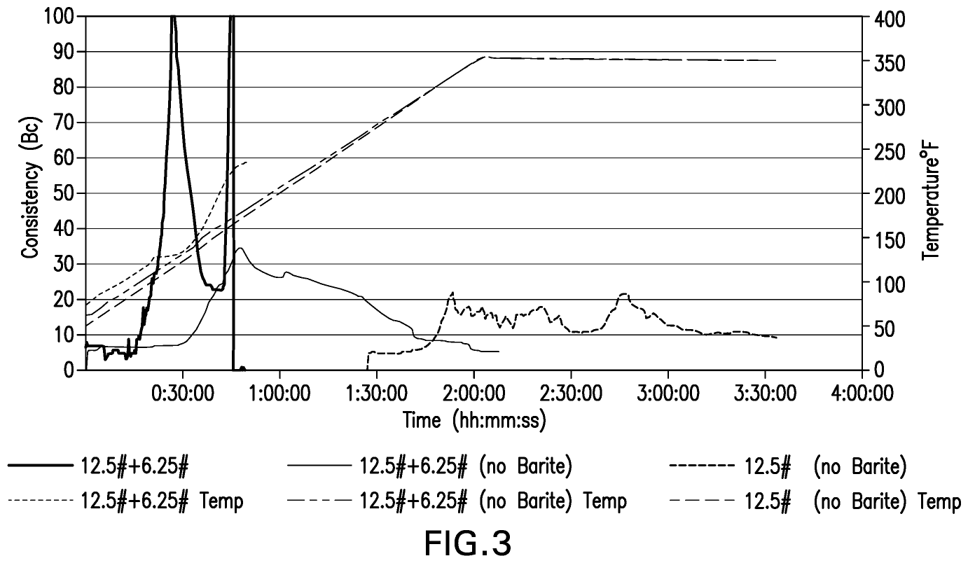

Samples H-J were prepared. Sample H contained water, 12.5 lb Laponite nanoclay, 6.25 lb magnesium oxide, and 14 ppg barite. Sample I contained water, 12.5 lb Laponite nanoclay, and 6.25 lb magnesium oxide. Sample J contained water and 12.5 lb Laponite nanoclay. The viscosity of Samples H-J over time at different temperatures was measured using a Chandler consistometer. The results are shown in FIG. 3.

The results indicate that the 12.5 lb system (Sample J) without calcined magnesium oxide or barite demonstrates a low viscosity at lower temperatures, then at over 250° F. the viscosity increases and maintains to the conclusion of the test. Sample I also showed a similar viscosity profile as sample J.

Set forth below are various embodiments of the disclosure.

Embodiment 1. A method of cementing a wellbore, the method comprising injecting into the wellbore a cement slurry comprising an aqueous carrier, a swellable nanoclay, and a solid delayed releasing divalent inorganic salt comprising calcined magnesium oxide, calcined calcium oxide, a calcium magnesium polyphosphate glass, a borate, a nitride, a silicate, an agent having a cation of Ba²⁺, Sr²⁺, Fe²⁺, Ni²⁺, or a combination comprising at least one of the foregoing; and allowing the cement slurry to set.

Embodiment 2. The method of Embodiment 1, wherein the water-swellable nanoclay is a synthetic layered silicate.

Embodiment 3. The method of Embodiment 2, wherein the synthetic layered silicate is a synthetic layered hectorite magnesium lithium silicate.

Embodiment 4. The method of any one of Embodiments 1 to 3, wherein the water-swellable nanoclay is present in an amount of about 0.1 wt. % to about 25 wt. % based on the weight of the aqueous carrier.

Embodiment 5. The method of any one of Embodiments 1 to 4, wherein the solid delayed releasing divalent inorganic salt is heat treated at a temperature of about 1500° C. to 2000° C. (2700° F. to about 3600° F.) before incorporated into the cement slurry.

Embodiment 6. The method of any one of Embodiments 1 to 4, wherein the solid delayed releasing divalent inorganic salt is heat treated at a temperature of about 1000° C. to 1500° C. (1800° F. to about 2700° F.) before incorporated into the cement slurry.

Embodiment 7. The method of any one of Embodiments 1 to 6, wherein the solid delayed releasing divalent inorganic salt is present in an amount of about 0.1 wt. % to about 5 wt. % based on the weight of the aqueous carrier.

Embodiment 8. The method of any one of Embodiments 1 to 7, wherein the wellbore has a wellbore temperature of greater than about 300° F.

Embodiment 9. The method of any one of Embodiments 1 to 8, wherein the cement slurry comprises about 0.1 wt. % to about 20 wt. % of a synthetic layered hectorite magnesium lithium silicate, and about 0.1 wt. % to about 5 wt. % of calcined magnesium oxide.

Embodiment 10. A method of displacing a first fluid from a wellbore, the method comprising injecting the first fluid into the wellbore; and displacing the first fluid with a spacer fluid comprising an aqueous carrier, a swellable nanoclay, and a solid delayed releasing divalent inorganic salt comprising calcined magnesium oxide, calcined calcium oxide, a calcium magnesium polyphosphate glass, a borate, a nitride, a silicate, an agent having a cation of Ba²⁺, Sr²⁺, Fe²⁺, Ni²⁺, or a combination comprising at least one of the foregoing.

Embodiment 11. The method of Embodiment 10, wherein the first fluid comprises a drilling fluid.

Embodiment 12. The method of Embodiment 10 or Embodiment 11, further comprising displacing the spacer fluid with a second fluid.

Embodiment 13. The method of Embodiment 12, wherein the second fluid is a cement slurry.

Embodiment 14. The method of Embodiment 13, wherein the cement slurry comprises an aqueous carrier, a swellable nonoclay, and a solid delayed releasing divalent inorganic salt comprising calcined magnesium oxide, calcined calcium oxide, a calcium magnesium polyphosphate glass, a borate, a nitride, a silicate, an agent having a cation of Ba²⁺, Sr²⁺, Fe²⁺, Ni²⁺, or a combination comprising at least one of the foregoing.

Embodiment 15. The method of any one of Embodiments 10 to 14, wherein the water-swellable nanoclay is a synthetic layered silicate.

Embodiment 16. The method of any one of Embodiments 10 to 15, wherein the synthetic layered silicate is a synthetic layered hectorite magnesium lithium silicate.

Embodiment 17. The method of any one of Embodiments 10 to 16, wherein the water-swellable nanoclay is present in the spacer fluid in an amount of about 1 wt. % to about 25 wt. % based on the weight of the aqueous carrier.

Embodiment 18. The method of any one of Embodiments 10 to 17, wherein the solid delayed releasing divalent inorganic salt is heat treated at a temperature of about 1000° C. to about 1500° C. before incorporated into the spacer fluid.

Embodiment 19. The method of any one of Embodiments 10 to 17, wherein the solid delayed releasing divalent inorganic salt is heat treated at a temperature of about 1500° C. to about 2000° C. before incorporated into the spacer fluid.

Embodiment 20. The method of any one of Embodiments 10 to 19, wherein the solid delayed releasing divalent inorganic salt is present in the spacer fluid in an amount of about 1 wt. % to about 25 wt. % based on the weight of the aqueous carrier.

Embodiment 21. The method of any one of Embodiments 10 to 20, wherein the spacer fluid comprises about 0.1 wt. % to about 20 wt. % of a synthetic layered hectorite magnesium lithium silicate, and about 0.1 wt. % to about 5 wt. % of calcined magnesium oxide.

Embodiment 22. The method of any one of Embodiments 10 to 21, wherein the wellbore has a wellbore temperature of greater than about 300° F.

All ranges disclosed herein are inclusive of the endpoints, and the endpoints are independently combinable with each other. As used herein, “combination” is inclusive of blends, mixtures, alloys, reaction products, and the like. All references are incorporated herein by reference in their entirety. The wellbore can be vertical, deviated or horizontal.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

1. A method of cementing a wellbore, the method comprising:
injecting into the wellbore a cement slurry comprising
an aqueous carrier,
a swellable nanoclay, and
a solid delayed releasing divalent inorganic salt comprising calcined magnesium oxide, calcined calcium oxide, a calcium magnesium polyphosphate glass, a borate, a nitride, a silicate, an agent having a cation of Ba²⁺, Sr²⁺, Fe²⁺, Ni²⁺, or a combination comprising at least one of the foregoing; and
allowing the cement slurry to set.

2. A method of displacing a first fluid from a wellbore, the method comprising
injecting the first fluid into the wellbore; and
displacing the first fluid with a spacer fluid comprising
an aqueous carrier,
a swellable nanoclay, and
a solid delayed releasing divalent inorganic salt comprising calcined magnesium oxide, calcined calcium oxide, a calcium magnesium polyphosphate glass, a borate, a nitride, a silicate, an agent having a cation of Ba²⁺, Sr²⁺, Fe²⁺, Ni²⁺, or a combination comprising at least one of the foregoing.

3. The method of claim 2, wherein the first fluid comprises a drilling fluid.

4. The method of claim 2, further comprising displacing the spacer fluid with a second fluid.

5. The method of claim 3, wherein the second fluid is a cement slurry.

6. The method of claim 5, wherein the cement slurry comprises an aqueous carrier, a swellable nonoclay, and a solid delayed releasing divalent inorganic salt comprising calcined magnesium oxide, calcined calcium oxide, a calcium magnesium polyphosphate glass, a borate, a nitride, a silicate, an agent having a cation of Ba²⁺, Sr²⁺, Fe²⁺, Ni²⁺, or a combination comprising at least one of the foregoing.

7. The method of claim 1, wherein the water-swellable nanoclay is a synthetic layered silicate.

8. The method of claim 1, wherein the synthetic layered silicate is a synthetic layered hectorite magnesium lithium silicate.

9. The method of claim 1, wherein the water-swellable nanoclay is present in the cement slurry in an amount of about 1 wt. % to about 25 wt. % based on the weight of the aqueous carrier.

10. The method of claim 1, wherein the solid delayed releasing divalent inorganic salt comprises calcined magnesium oxide, calcined calcium oxide, a calcium magnesium polyphosphate glass, or a combination comprising at least one of the foregoing.

11. The method of claim 1, wherein the solid delayed releasing divalent inorganic salt is heat treated at a temperature of about 1000° C. to about 1500° C. before incorporated into the cement slurry.

12. The method of claim 1, wherein the solid delayed releasing divalent inorganic salt is heat treated at a temperature of about 1500° C. to about 2000° C. before incorporated into the cement slurry.

13. The method of claim 1, wherein the solid delayed releasing divalent inorganic salt is present in the cement slurry in an amount of about 1 wt. % to about 25 wt. % based on the weight of the aqueous carrier.

14. The method of claim 1, wherein the cement slurry comprises about 0.1 wt. % to about 20 wt. % of a synthetic layered hectorite magnesium lithium silicate, and about 0.1 wt. % to about 5 wt. % of calcined magnesium oxide.

15. The method of claim 1, wherein the wellbore has a wellbore temperature of greater than about 300° F.

16. The method of claim 2, wherein the water-swellable nanoclay is a synthetic layered silicate.

17. The method of claim 2, wherein the water-swellable nanoclay is present in the spacer fluid in an amount of about 1 wt. % to about 25 wt. % based on the weight of the aqueous carrier.

18. The method of claim 2, wherein the solid delayed releasing divalent inorganic salt comprises calcined magnesium oxide, calcined calcium oxide, a calcium magnesium polyphosphate glass, or a combination comprising at least one of the foregoing.

19. The method of claim 2, wherein the solid delayed releasing divalent inorganic salt is present in the spacer fluid in an amount of about 1 wt. % to about 25 wt. % based on the weight of the aqueous carrier.

20. The method of claim 2, wherein the spacer fluid comprises about 0.1 wt. % to about 20 wt. % of a synthetic layered hectorite magnesium lithium silicate, and about 0.1 wt. % to about 5 wt. % of calcined magnesium oxide.
